(19) United States
(12) Patent Application Publication
(10) Pub. No.: US 2011/0316453 A1
(43) Pub. Date: Dec. 29, 2011

(54) LIGHTING CONTROL SYSTEMS AND METHODS

(76) Inventor: David B. Ewing, Madison, AL (US)

(21) Appl. No.: 13/171,863

(22) Filed: Jun. 29, 2011

Related U.S. Application Data
(60) Provisional application No. 61/359,461, filed on Jun. 29, 2010.

(51) Int. Cl. H05B 37/02

(52) U.S. Cl. 315/362

(57) ABSTRACT

The present disclosure generally pertains to lighting control systems and methods. In one exemplary embodiment, a building having at least one light source controlled by a manually-actuated switch is retrofitted with a networked control system. In this regard, the manually-actuated switch is decoupled from a power line that provides power to the light source, and the power line is coupled to a node of a wireless network to provide in-line control of the light source. Another node of the network is coupled to the manually-actuated switch so that the node can receive inputs from such switch. Such node uses the wireless network to transmit data indicative of the inputs from the manually-actuated switch. Logic then uses such data to control the activation state of the light source via the in-line relay coupled to the power line.

### CROSS REFERENCE TO RELATED APPLICATION

This application claims priority to U.S. Provisional Patent Application No. 61/359,461, entitled “Lighting Control Systems and Methods” and filed on Jun. 29, 2010, which is incorporated herein by reference.

### RELATED ART

Lighting systems within residential and commercial buildings have generally been controlled by manually-actuated switches, which are often mounted on building walls. To turn on a light source, a user manually moves a switch to one state and then moves the switch to another state to turn off the same light source. Oftentimes, it is desirable for one or more light sources to be turned off during certain times of the day and/or when there are no users present in order to conserve electrical power and reduce energy costs. However, users often fail to turn off the light sources in the desired manner. As an example, a user may neglect to turn off one or more light sources when leaving a room or turn on a light source in the middle of the day when there is sufficient sunlight such that use of the light source is not needed.

Accordingly, light timers have been developed that allow automatic control of light sources. Such a light timer is attached to the power cord of a light source, such as a lamp, and automatically activates and/or deactivates the light source based on the time of day. If desired, the timer function can be overridden by manual input if a user desires to control the light source in a manner different than that programmed into the light timer.

More recently, efforts have been made to provide centralized control of lighting systems. In this regard, decisions about the activation states of one or more lights sources are made at a central controller, which can make such decisions based on various input, such as time of day and/or manual inputs. However, many existing buildings are equipped with manually-actuated switches and retrofitting such buildings with a centrally-controlled lighting system can be problematic and expensive.

### BRIEF DESCRIPTION OF THE DRAWINGS

The disclosure can be better understood with reference to the following drawings.

The elements of the drawings are not necessarily to scale relative to each other, emphasis instead being placed upon clearly illustrating the principles of the disclosure. Furthermore, like reference numerals designate corresponding parts throughout the several views.

FIG. 1 depicts a conventional lighting system for a room of a building.

FIG. 2 depicts the room of FIG. 1 after it has been retrofitted with a lighting system in accordance with an exemplary embodiment of the present disclosure.

FIG. 3 is a block diagram illustrating an exemplary embodiment of a network node having an in-line relay for controlling an activation state of a light source depicted by FIG. 2.

FIG. 4 depicts the exemplary room of FIG. 2 with various components removed for simplicity of illustration.

FIG. 5 depicts a bottom view of a drop-down ceiling of the room depicted by FIG. 2.

FIG. 6 is a block diagram illustrating an exemplary embodiment of a network node coupled to a wall-mounted switch depicted by FIG. 2.

FIG. 7 is a side view illustrating an exemplary embodiment of a wall-mounted switch, such as is depicted by FIG. 2.

FIG. 8 is a side view illustrating the wall-mounted switch of FIG. 7 after the switch has been actuated to change a state of the switch.

### DETAILED DESCRIPTION

The present disclosure generally pertains to lighting control systems and methods. In one exemplary embodiment, a building having at least one light source controlled by a manually-actuated switch is retrofitted with a networked control system. In this regard, the manually-actuated switch is decoupled from a power line that provides power to the light source, and the power line is coupled to a node of a wireless network to provide in-line control of the light source. Another node of the network is coupled to a manually-actuated switch so that the node can receive inputs from such switch. Such node uses the wireless network to transmit data indicative of the inputs from the manually-actuated switch. Logic then uses such data to control the activation state of the light source via the in-line relay coupled to the power line.

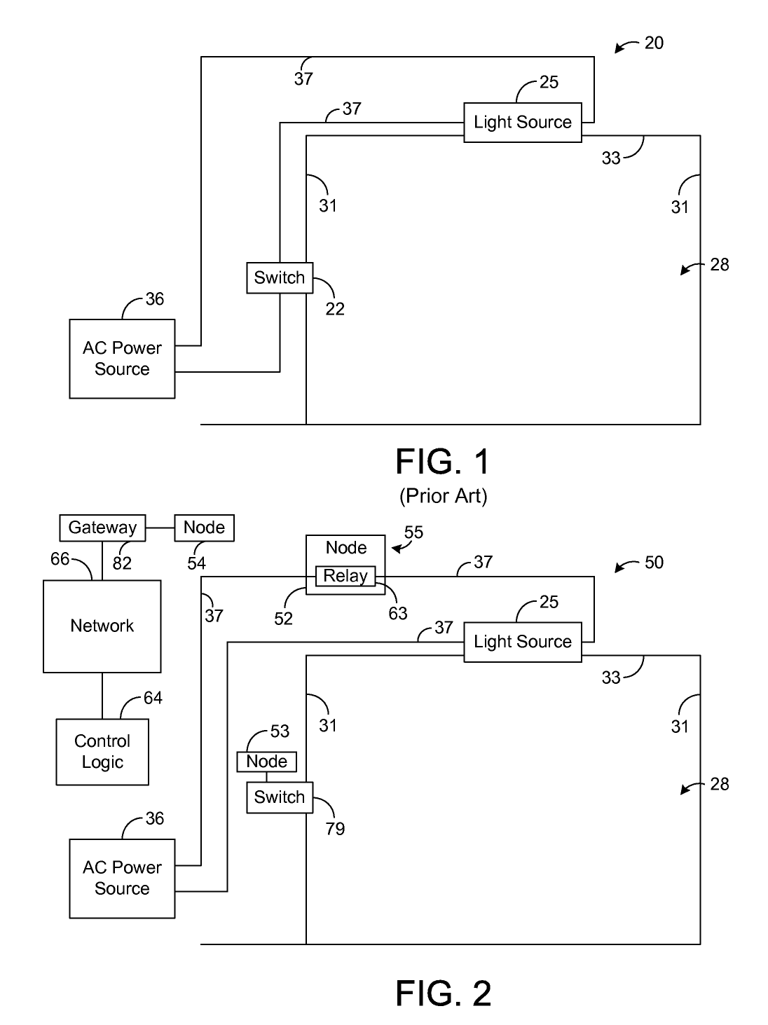

Residential and commercial buildings often have wall-mounted switches for controlling lighting within such buildings. FIG. 1 depicts a typical lighting system 20 that uses a wall-mounted switch 22 to control the lighting state of a light source 25 or other electrical apparatus. The light source 25 comprises any known or future-developed apparatus for emitting light in response to electrical current, such as at least one incandescent or florescent bulb or light emitting diode (LED). When activated, the light source 25 provides light within a room 28 of a building. As shown by FIG. 1, the room 28 has a plurality of walls 31 and a ceiling 33. The light source 25 is mounted on the ceiling 33, and the switch 22 is mounted on one of the walls 31. Such wall 31 has a cavity (not shown in FIG. 1) in which components of switch 22 reside.

The switch 22 and the light source 25 are coupled to an alternating current (AC) power source 36 via a conductive power line 37, as shown by FIG. 1. The power source 36 may comprise a generator or a utility power line that provides electrical power to a plurality of buildings, although other types of power sources are possible. If desired, a transformer may be used such that electrical current can be transmitted at a high voltage along the utility power line and then converted to a lower voltage for use in the building. The electrical current provided by the AC power source 36 is about 120 Volts (V) and about 60 Hertz (HZ), but other types of electrical signals may be used, if desired.

The switch 22 is manually-actuated such that the state of the switch 22 can be manually controlled by a user. In this regard, a user can manually transition the switch 22 between an open state and a closed state. When in the open state, the switch 22 operates as an open circuit preventing current from flowing through the switch. In such state, the light source 25 does not emit light and shall be referred to as “deactivated.” When the user transitions the switch 22 to the closed state, the switch 22 operates as a short circuit allowing current to flow through the light source 25. In such state, the light source 25 emits light and shall be referred to as “activated.”

In one exemplary embodiment of the present disclosure, the room 28 is retrofitted with a lighting system 50 (FIG. 2) that controls the state of the light source 25 via a node 52, which is a member of a wireless network 55. In this regard, the node 52 and, more specifically, a relay 55 of the node 52 is inserted in-line between the light source 25 and the AC power source 36. For example, a power line 37 for carrying current provided by the AC power source 36 may be severed and then electrically coupled to a relay 55 of the node 52. The node 52 is configured to control a state of the relay 55 and, hence, the light source 25 based on control logic 64 or otherwise.

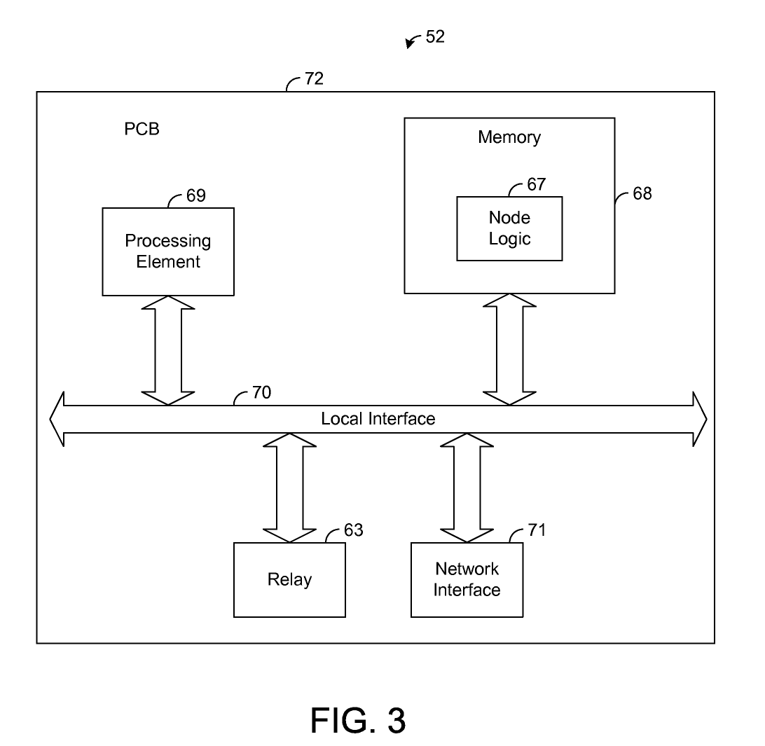

FIG. 3 depicts an exemplary embodiment of the node 52. As shown by FIG. 3, the node 52 comprises node logic 67 that generally controls the operation of the node 52. Such logic 67 can be implemented in software, hardware, firmware, or any combination thereof. In an exemplary embodiment illustrated in FIG. 3, the node logic 67 is implemented in software and stored in memory 68.

Note that the node logic 67, when implemented in software, can be stored and transported on any computer-readable medium for use by or in connection with an instruction execution apparatus that can fetch and execute instructions. In the context of this document, a “computer-readable medium” can be any means that can contain or store a program for use by or in connection with an instruction execution apparatus.

The exemplary embodiment of the node 52 depicted by FIG. 3 comprises at least one conventional processing element 69, such as a digital signal processor (DSP) or a central processing unit (CPU), that communicates to and drives the other elements within the node 52 via a local interface 70, which can include at least one bus. Furthermore, the node 52 comprises a network interface 71 for communicating with other nodes 53 and 54 of a wireless network 55. In one exemplary embodiment, the network interface 71 communicates wireless signals (e.g., radio frequency signals) with the other nodes 53 and 54, but other types of signals may be communicated in other embodiments. As shown by FIG. 3, the components of the node 52 are mounted on a printed circuit board (PCB) 72, but other arrangements of the node 52 are possible in other embodiments.

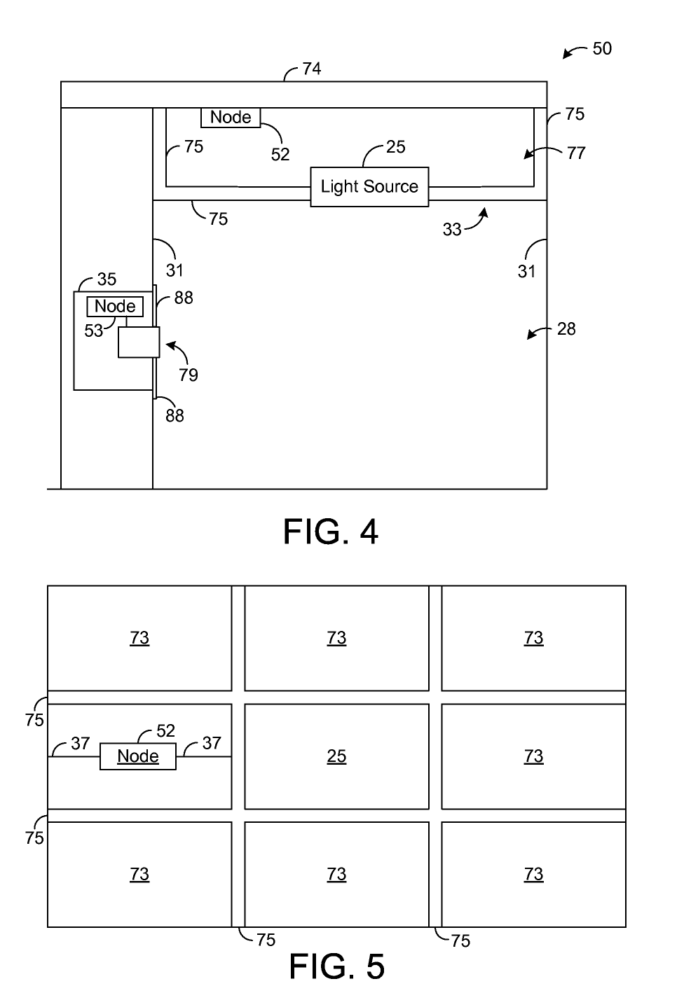

In the exemplary embodiment shown by FIG. 2, the node 52 is mounted on the ceiling 33. FIG. 4 depicts the room 28 of FIG. 2 showing additional details for the ceiling 33 with various components such as the power line 37 and power source 36 removed for illustrative purposes. As shown by FIG. 4, the ceiling 33 is a drop-down ceiling having a plurality of removable panels 73 (FIG. 5) that are suspended below a structure 74 supporting the panels 73. Such a structure 74 may form a floor of a room that is higher than the room 28 shown by FIG. 2. Alternatively, the structure 74 may form the roof of the building in which the room 28 is located. Other types of structures 74 for supporting the panels of the drop down ceiling 33 are possible in other embodiments.

As shown by FIG. 4, the drop-down ceiling 33 has a frame 75 that is coupled to and extends from the structure 74 thereby forming a drop space 77 between the structure 74 and the panels 73. In one exemplary embodiment, the frame 75 is patterned to form a plurality of rectangular-shaped cells into which the panels 73 respectively fit such that the panels 73 are positioned on and held by the frame 74. Note that each panel 73 has the same cross-sectional shape and approximately the same length and width of its respective cell, and in other embodiments, non-rectangular shapes are possible. Each panel 73 may be removed from its respective cell by lifting the panel 73 off of the frame 75. FIG. 5 shows a bottom view of the ceiling 33 with one of the panels 73 removed exposing the node 52.

To insert the relay 63 in-line between the light source 25 and the AC power source 36, at least one panel 73 of the drop-down ceiling 33 may be removed to provide access to the power line 37 that is to be severed. Once the node 52 is installed and the relay 63 is electrically coupled to the power line 37, the removed panel 73 or panels 73 may be replaced to hide the node 52 from view, if desired. Note that a drop-down ceiling 33 provides easy access to the wiring for the light source 25. However, the use of a drop-down ceiling 33 is unnecessary, and other types of ceilings may be used for the room 28, if desired. In addition, it is unnecessary for the node 52 to be located on or within the ceiling 33. As an example, the node 52 and, more specifically, the relay 63 of the node 52 may be inserted in-line near a circuit breaker (not shown) for the light source 25 or other location at which a user can access the wiring for the light source 25.

In one exemplary embodiment, the control logic 64 is remote from the nodes 52-54 of the wireless network 55 and communicates with the nodes 52-54 through a network 66, such as a local area network (LAN), wide area network (WAN), or other type of network. The network 66 may comprise the Internet, but other types of networks are possible. For illustrative purposes, it will be assumed hereafter that the network 66 comprises the Internet.

As shown by FIG. 2, a node 54 of the wireless network 55 is communicatively coupled to a gateway 82 that provides access to the network 66. The node 54 may be conductively coupled to the gateway 82 or alternatively communicate with the gateway 82 via wireless signals. If desired, the nodes 53 and 54 may communicate with the control logic 64 via the node 54. For example, to transmit a message to the control logic 64, the node 53 may transmit the message to the node 54, which encapsulates the message via TCP/IP or some other desired protocol for communication across the network 66. The node 54 then transmits the message to the gateway 82 so that the message propagates through the network 66 to the control logic 64. Similarly, a message may be transmitted from the node 54 to the control logic 64.

In addition, the control logic 64 may transmit a message through the network 66 destined for one of the nodes 52 or 53. Such message is received by the node 54 from the gateway 82, and the node 54 may de-encapsulate the message to remove overhead used by the network 66. The node 54 may then forward the message to the appropriate node 52 or 53. If the nodes 52 and 53 are within range of the gateway 82, they may communicate with the gateway 82 directly via wireless signals without communicating through the node 54. In such case, the encapsulation and de-encapsulation described above as performed by the node 54 may instead be performed by the nodes 52 and 53. Various other modifications and changes regarding the communication between the control logic 64 and the nodes 52 and 53 are possible.

In addition, the control logic 64 may be local to the node 52 such that communication through a network 66 is unnecessary. As an example, the control logic 64 may reside on the PCB 72 (FIG. 3) of the node 52 and control the relay 63 directly. In another embodiment, the control logic 64 may reside on and be implemented within the node 54, and the control logic 64 may communicate with the nodes 52 and 53 wirelessly.

Note that the control logic 64 may be implemented in hardware, software, firmware, or any combination thereof. When implemented in software, the control logic 64 can be stored and transported on any computer-readable medium for use by or in connection with an instruction execution apparatus that can fetch and execute instructions.

In retrofitting the room 28, the switch 22 is removed from the wall 31, and the power line ends previously connected to the switch 22 are soldered together or otherwise joined such that the switch 22 is removed from the circuit for supplying power to the light source 25, as shown by FIG. 2.

When the control logic 64 determines that the light source 25 is to transition to the deactivated state, the control logic 64 transmits a message, referred to hereafter as “deactivation command,” instructing the node 52 to deactivate the light source 25. In response, the node 52 is configured to transition the relay 63 to an open state such that current is prevented from flowing through the relay 63. Thus, current is prevented from flowing through the light source 25 thereby preventing the light source 25 from emitting light.

When the control logic 64 determines that the light source 25 is to transition to the activated state, the control logic 64 transmits a message, referred to hereafter as “activation command,” instructing the node 52 to activate the light source 25. In response, the node 52 is configured to transition the relay 63 to a closed state such that current is allowed to flow through the relay 63. Thus, current generated or otherwise provided by the AC power device 36 passes through the light source 25 causing it to emit light.

In one exemplary embodiment, the switch 22 is replaced by a node 53 of the wireless network 55 and a manually-actuated switch 79. In other embodiments, the same switch 22 may be coupled to the node 53 instead of a new switch 79. Commonly-assigned U.S. patent application Ser. No. 12/463,050, entitled “Systems and Methods for Communicating Messages in Wireless Networks,” and filed on May 8, 2009, which is incorporated herein by reference, describes exemplary nodes that may be used to implement the wireless network 55. The node 53 may be inserted into and reside in the wall cavity 35 in which the switch 22 was previously inserted, but other locations of the node 53 are possible in other embodiments. The node 53 is coupled to the switch 79, and the switch 79 preferably has a faceplate 88 that hides the cavity 35 and, hence, the node 53 from view. However, such a faceplate 88 is unnecessary and may be omitted if desired.

In one exemplary embodiment, the node 53 is configured to communicate wirelessly with the node 52. Note that it is unnecessary for a wireless network 55 to be employed, and it is possible for the node 53 to be coupled to the node 52 via conductive wires for enabling communication between the nodes 52 and 53. However, for illustrative purposes, it will be assumed hereafter that the nodes 52 and 53 communicate with each other wirelessly.

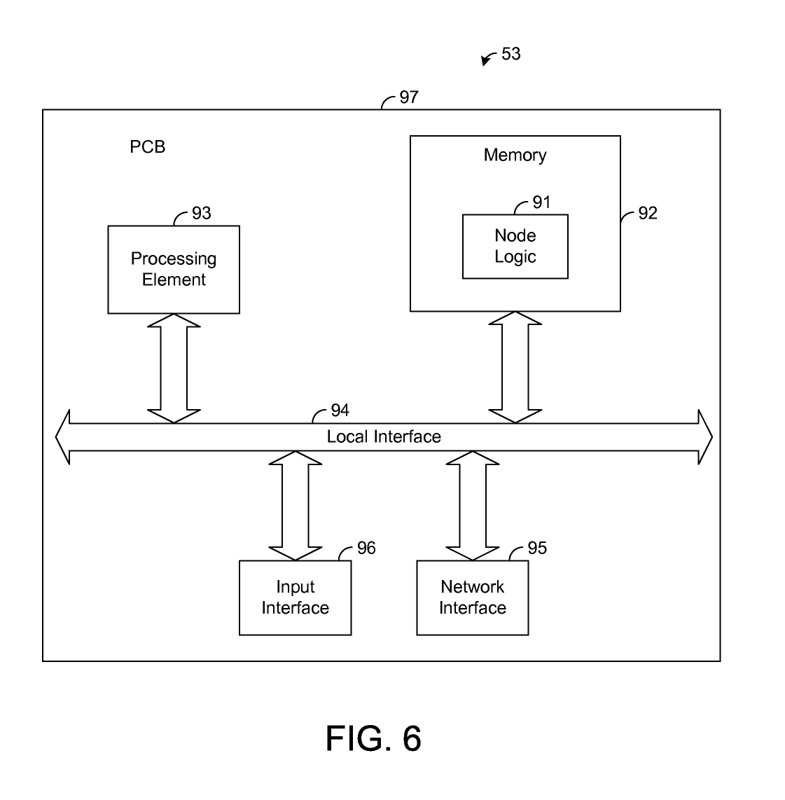

FIG. 6 depicts an exemplary embodiment of the node 53. As shown by FIG. 6, the node 53 comprises node logic 91 that generally controls the operation of the node 53. Such logic 91 can be implemented in software, hardware, firmware, or any combination thereof. In the exemplary embodiment illustrated in FIG. 6, the node logic 91 is implemented in software and stored in memory 92. Note that the node logic 91, when implemented in software, can be stored and transported on any computer-readable medium for use by or in connection with an instruction execution apparatus that can fetch and execute instructions.

The exemplary embodiment of the node 53 depicted by FIG. 6 comprises at least one conventional processing element 93, such as a digital signal processor (DSP) or a central processing unit (CPU), that communicates to and drives the other elements within the node 53 via a local interface 94, which can include at least one bus. Furthermore, the node 53 comprises a network interface 95 for communicating with other nodes 52 and 54 of the network 55. In one exemplary embodiment, the network interface 95 communicates wireless signals (e.g., radio frequency signals) with the other nodes 52 and 54, but other types of signals may be communicated in other embodiments. The node 53 also comprises an input interface 96 that is coupled to the switch 79 (FIG. 2). As shown by FIG. 6, the components of the node 52 are mounted on a printed circuit board (PCB) 97, but other arrangements of the node 53 are possible in other embodiments.

The switch 79 can be manually actuated by a user, and the switch 79 may appear similar to the switch 22 that was removed so that a user is unable to discern replacement of the switch 22 by viewing the switch 79. However, the switch 79 may be of a different type and/or appear different than the switch 22, if desired.

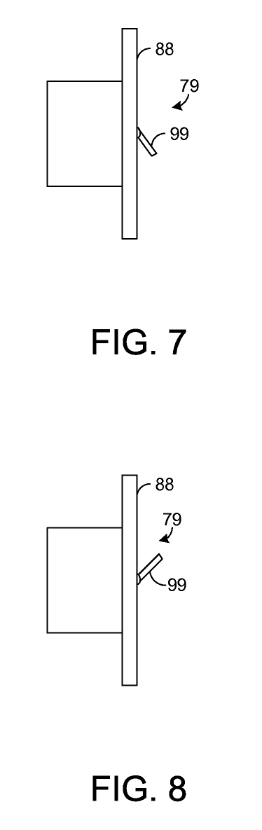

An exemplary embodiment of the switch 79 is depicted by FIG. 7. As shown, the exemplary switch 79 has a movable arm 99 extending through a hole in the faceplate 88. The state of the switch 79 can be changed by moving the arm from the position shown by FIG. 7 to the position shown by FIG. 8 and vice versa.

When a user desires to change a state of the light source 25 (e.g., either activate or deactivate the light source 25), the user may indicate such desire by actuating the switch 79, similar to the manner that the user previously would actuate the switch 22 of the conventional system 20 to control the light source 25. The node logic 91 of the node 53 is configured to sense such actuation of the switch 79, and in response, to transmit a notification message to the node 52. A decision about controlling the state of the light source 25 may then be made based on such notification.

As an example, the node logic 67 of the node 52 may be configured to automatically transition the state of the light source 25 in response to the notification. Alternatively, the node logic 67 may forward the notification to the control logic 64, which then determines whether to change the state of the light source 25 based on the notification. Such transition may be automatic, or the control logic 64 may use the notification as a factor in its control of the light source 25. The algorithm for controlling the light source 25 by the control logic 64 may allow the manual input by the user at the switch 79 to control the state of the light source 25 under certain circumstances, such as during certain times of the day, and may not allow such manual input to control the state of the light source 25 under other conditions, such as during other times of the day. The control logic 64 may implement any desired algorithm for controlling the state of the light source 25, and the implemented algorithm may be based on at least one manual input provided by a user via the switch 79. Further, to allow the control logic 64 to make decisions based on the time of day, the control logic 64 may comprise a timer that allows the control logic 64 to track time and use the tracked time to make decisions regarding the activation state of the light source 25.

Note that the node 53 may be coupled to a plurality of switches 79 so that the user can provide various combinations of inputs via the node 53. As an example, each switch 79 may correspond to a different light source or other electrical apparatus. For each such light source or other electrical apparatus, a node (similar to the node 52) may be inserted in-line such that current for powering the light source or other electrical apparatus passes through the node allowing a relay on the node to control the activation state of the light source or other electrical apparatus. In such case, manual actuation of any switch 79 indicates a desire to change the state of the light source or other electrical apparatus corresponding to the actuated switch, and the state of the light source or other electrical apparatus may be controlled based on such input as is described above for the light source 25.

In addition, communication between the nodes 52 and 53 is unnecessary in other embodiments. For example, the node 53 may be configured to notify the control logic 64 via the network 66 or otherwise of actuations of the switch 79 without communicating through the node 52. The control logic 64 may thereafter communicate with the node 52 to control the state of the light source 25 based on notifications from the node 53. Various other changes and modifications would be apparent to one of ordinary skill upon reading this disclosure.

1. A lighting system, comprising:
a light source;
a power source coupled to the light source via a power line;
a manually-actuated switch having a faceplate covering a cavity in a wall of a building;
a first node of a wireless network coupled to the manually-actuated switch and positioned within the cavity, the first node configured to receive a user input from the manually-actuated switch and to wirelessly transmit data indicative of the user input via the wireless network;
a second node of the wireless network, the second node having an in-line relay coupled to the power line; and
logic configured to receive the data and to control the in-line relay based on the data.

2. The system of claim 1, wherein the logic is configured to control the in-line relay based on a time of day.

3. The system of claim 1, wherein the second node is configured to transmit the data to the first node.

4. The system of claim 1, wherein the logic resides on the first node.

5. The system of claim 1, wherein the manually-actuated switch is electrically isolated from the power line.

6. The system of claim 1, wherein the second node is positioned within a drop space of a drop-down ceiling.

7. A method for use in a lighting system, comprising:
manually actuating a switch having a faceplate covering a cavity in a wall of a building;
wirelessly transmitting data indicative of the actuating from a first node coupled to the switch within the cavity;
determining whether to activate a light source based on the data, the light source coupled to a power source via a power line; and
controlling an in-line relay coupled to the power line based on the determining.

8. The method of claim 7, wherein the determining is based on a time of day.

9. The method of claim 7, wherein the transmitting comprises transmitting the data from the first node to the second node.

10. The method of claim 7, wherein the second node is positioned within a drop space of a drop-down ceiling.

11. A lighting method for a room of a building, the room having a light source coupled to a power source via a power line, comprising:
inserting a first node of a wireless network into a cavity within a wall of the building;
coupling a relay of a second node of the wireless network to the power line;
coupling a manually-actuated switch to the first node;
receiving a user input via the switch;
transmitting data indicative of the user input from the first node to the second node; and
controlling the relay based on the transmitted data.

12. The method of claim 11, wherein the controlling is based on a time of day.

13. The method of claim 11, wherein the switch covers the cavity.

14. The method of claim 11, wherein the second node is positioned within a drop space of a drop-down ceiling.
